(19) United States
(12) Patent Application Publication
(10) Pub. No.: US 2026/0177892 A1
(43) Pub. Date: Jun. 25, 2026

(54) PRECISION POSITIONING DEVICE

(71) Applicant: KOREA AEROSPACE RESEARCH INSTITUTE, Daejeon (KR)

(72) Inventors: Won Beom Lee, Sejong-si (KR); Deog Gyu Lee, Daejeong (KR)

(21) Appl. No.: 19/377,610

(22) Filed: Nov. 3, 2025

(30) Foreign Application Priority Data
Dec. 23, 2024 (KR) 10-2024-0194218

(51) Int. Cl. G03B 17/56

(52) U.S. Cl. CPC G03B 17/561

(57) ABSTRACT

A precision positioning device for adjusting the position of an object includes a base plate in which a through-hole is formed, a first alignment unit positioned on one side of the through-hole and configured such that the object is fixed thereto, and a second alignment unit surrounding at least a portion of the first alignment unit and fixed to the base plate, wherein the second alignment unit may include a tilting portion configured to tilt the first alignment unit by thermally expanding according to a temperature change.

### TECHNICAL FIELD

The following embodiments relate to a precision positioning device.

### BACKGROUND ART

Electro-optical cameras demand precision assembly and alignment; however, even subsequent to such assembly and alignment, slight focus shifts may nonetheless arise as a result of external environmental influences (e.g., moisture, vacuum, temperature variations, and vibration). As these focus variations cause deterioration in the optical system's performance, there is a need for a positioning device configured to precisely adjust the focus. For example, Korean Unexamined Patent Application Publication No. 10-2024-0065757 discloses a micro-positioning device.

### SUMMARY OF THE INVENTION

### Problem to be Solved

An object of an embodiment is to provide a precision positioning device that adjusts the position and angle of an object using thermal expansion.

An object of an embodiment is to provide a precision positioning device capable of tilting or translationally moving.

An object of an embodiment is to provide a precision positioning device capable of multi-axis control of an object.

### Solution to the Problem

A precision positioning device for adjusting the position of an object according to one embodiment comprises a base plate having a through-hole formed therein, a first alignment unit disposed on one side of the through-hole and configured to fix the object, and a second alignment unit surrounding at least a portion of the first alignment unit and secured to the base plate, wherein the second alignment unit may include a tilting portion configured to tilt the first alignment unit by thermal expansion in response to a temperature change.

In one embodiment, the tilting portion comprises at least one beam that is in contact with the base plate and extends in a first direction perpendicular to the base plate, a bracket seated on one end of the beam and disposed so as to be spaced apart from the base plate, and a connecting plate seated on the bracket and coupled to the first alignment unit, wherein the beam may thermally expand in the first direction in response to a temperature change to exert a force on the bracket.

In one embodiment, the beam comprises a first beam surface that is in contact with the base plate, a second beam surface opposite to the first beam surface, and a beam side surface disposed between the first beam surface and the second beam surface, and the tilting portion may include at least one beam heater attached to the beam side surface.

In an embodiment, the tilting portion may include a beam insulating member interposed between the second beam surface and the bracket.

In an embodiment, a groove penetrating the beam side surface may be formed on the beam side surface.

In one embodiment, the second alignment unit comprises a plurality of the tilting portions, and when any one of the pluralities of tilting portions tilts the connecting plate, the width of the groove of at least one other tilting portion may decrease.

In one embodiment, the tilting portion may comprise a temperature sensor affixed to a surface opposite to the surface to which the beam heater is attached, the temperature sensor being configured to sense the temperature of the beam.

In an embodiment, the second alignment unit may comprise a translational movement portion configured to cause translational movement of the first alignment unit by thermal expansion in response to a temperature change.

In one embodiment, the translational movement portion comprises a connecting ring coupled to the connecting plate and a pusher disposed radially outside the connecting ring, the pusher being configured to thermally expand in response to a temperature change to apply a force to the connecting ring in the radial direction.

In one embodiment, the pusher comprises a pusher first surface facing the connecting plate, a pusher second surface opposite to the pusher first surface, and a pusher side surface disposed between the pusher first surface and the pusher second surface, and the translational movement portion may include at least one pusher heater affixed to the pusher side surface.

In one embodiment, the translational movement portion comprises a temperature sensor configured to sense the temperature of the pusher, the temperature sensor being disposed in a cavity formed in the pusher, and the pusher heater may be affixed to a surface other than the surface on which the temperature sensor is disposed.

In an embodiment, the translational movement portion may include a pusher insulating member interposed between the pusher and the connecting ring.

In an embodiment, the connecting plate and the connecting ring are screw-coupled, and a flexure groove may be formed in the connecting plate around a screw hole of the connecting plate.

In an embodiment, the first unit comprises a first body extending in a first direction perpendicular to the base plate, the first body having a hollow formed concentrically with the through-hole of the base plate, the first body including a first body surface, a second body surface opposite the first body surface, and a first body side surface disposed between the first body surface and the second body surface, and a second body extending in the first direction, at least partially surrounded by the first body, and including a second body first surface, a second body second surface opposite the second body first surface, and a second bodyside surface positioned between the second body first surface and the second body second surface, wherein at least one of the first body and the second body may thermally expand in the first direction in response to a temperature change.

In an embodiment, the first alignment unit includes an isolator that connects the second surface of the first body and the second surface of the second body to each other in the first direction while maintaining a predetermined spacing therebetween, a first body heater attached to the first body side surface, and a second body heater attached to the second body side surface, wherein when the first body thermally expands, the second body translates in the first direction, and when the second body thermally expands, the second surface of the second body may translate in a second direction opposite to the first direction.

### Advantageous Effects of the Invention

A precision positioning device according to an embodiment can adjust the position and angle of an object using thermal expansion.

A precision positioning device according to an embodiment can tilt or translationally move an object.

A precision positioning device according to an embodiment can perform multi-axis control of an object.

The effects of the precision positioning device according to one embodiment are not limited to those described above, and other effects not expressly mentioned will be readily understood by those skilled in the art from the description below.

### BRIEF DESCRIPTION OF DRAWINGS

FIGS. 1 and 2 are perspective views of a precision positioning device according to one embodiment.

FIG. 3 is a plan view of a precision positioning device according to one embodiment.

FIG. 4 is an enlarged view of portion Ain FIG. 1.

FIGS. 5 and 6 are perspective views of a second alignment unit according to an embodiment.

FIG. 7 is a side view of a second alignment unit according to an embodiment.

FIG. 8 is a perspective view of a second alignment unit according to an embodiment with a portion thereof omitted.

FIG. 9 is a perspective view of a second alignment unit according to an embodiment with a portion thereof omitted.

FIG. 10 is a plan view of a portion of the second alignment unit illustrated in FIG. 9.

FIGS. 11 and 12 are perspective views of a first alignment unit according to an embodiment.

### DETAILED DESCRIPTION OF THE INVENTION

Hereinafter, embodiments are described in detail with reference to the accompanying drawings. However, various modifications may be made to the embodiments, and the scope of the patent application is not to be limited or restricted by these embodiments. It should be understood that all modifications, equivalents, and substitutes to the embodiments are encompassed within the scope of the claimed invention.

The terms used in the embodiments are for descriptive purposes only and should not be construed as limiting. Singular expressions include plural expressions unless the context clearly indicates otherwise. In this specification, terms such as “comprising” or “having” are intended to designate the presence of a feature, number, step, operation, component, part, or combination thereof described herein, and should be understood as not precluding the presence or addition of one or more other features, numbers, steps, operations, components, parts, or combinations thereof.

Unless otherwise defined, all terms used herein, including technical and scientific terms, shall have the same meaning as commonly understood by those of ordinary skill in the art to which the embodiments pertain. Terms defined in commonly used dictionaries shall be interpreted as having a meaning consistent with their meaning in the context of the relevant technology and shall not be construed in an idealized or unduly formal sense unless expressly defined in the present application.

In addition, in the description with reference to the accompanying drawings, identical components are assigned the same reference numerals regardless of the drawing numbers, and redundant description thereof shall be omitted. When describing an embodiment, if it is determined that a detailed description of related known technology may unnecessarily obscure the gist of the embodiment, such detailed description shall be omitted.

Additionally, in describing components of an embodiment, terms such as first, second, A, B, (a), and (b) may be used. These terms are only intended to distinguish one component from another, and do not limit the essence, order, or sequence of the component. When a component is described as being “connected,” “coupled,” or “joined” to another component, it shall be understood that the component may be directly connected or joined to the other component, but it shall also be understood that another component may be interposed between the components, or that the components may be “connected,” “coupled,” or “joined” through another component.

Components included in one embodiment and components that include common functions will be described using the same names in other embodiments. Unless otherwise stated, the description provided in one embodiment may also apply to other embodiments, and detailed description shall be omitted to the extent it would be redundant.

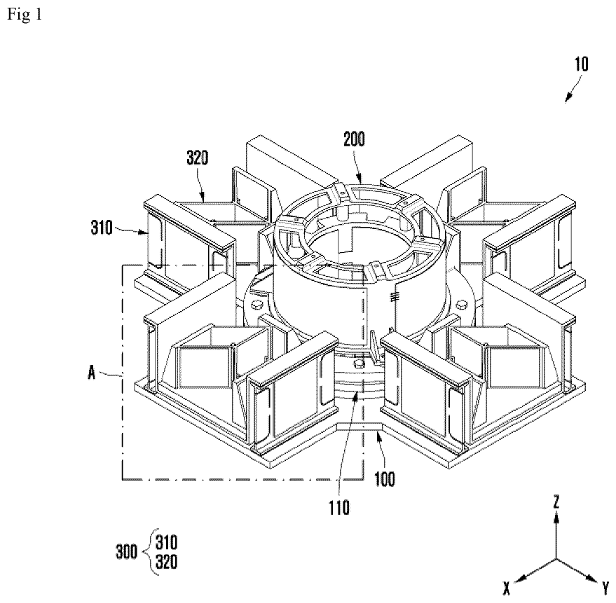

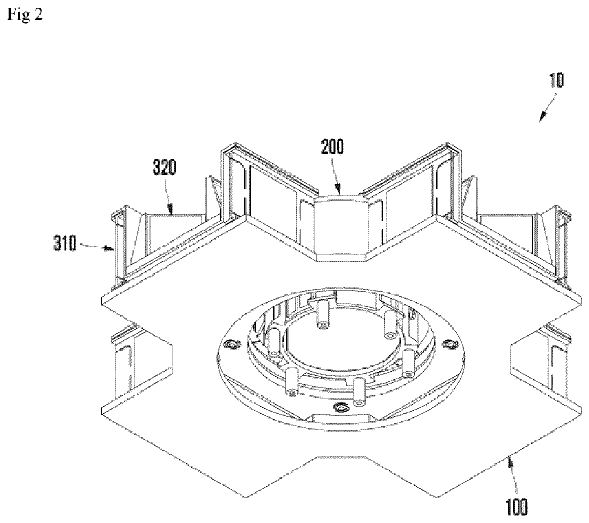

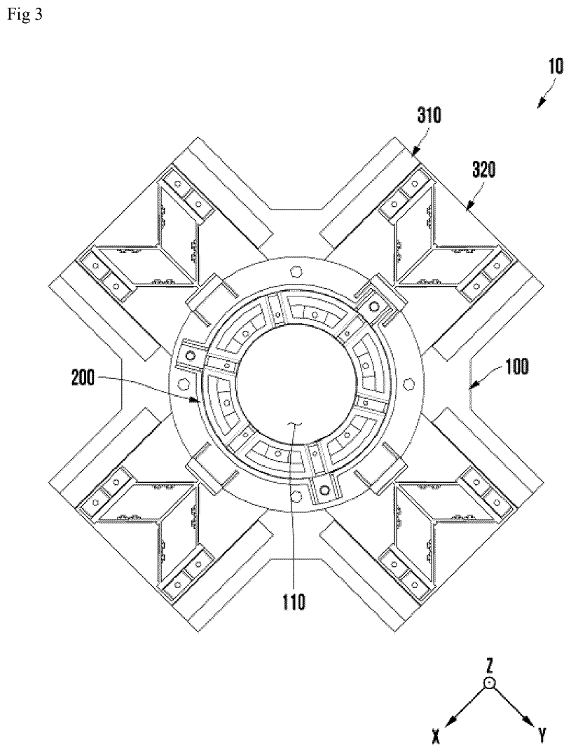

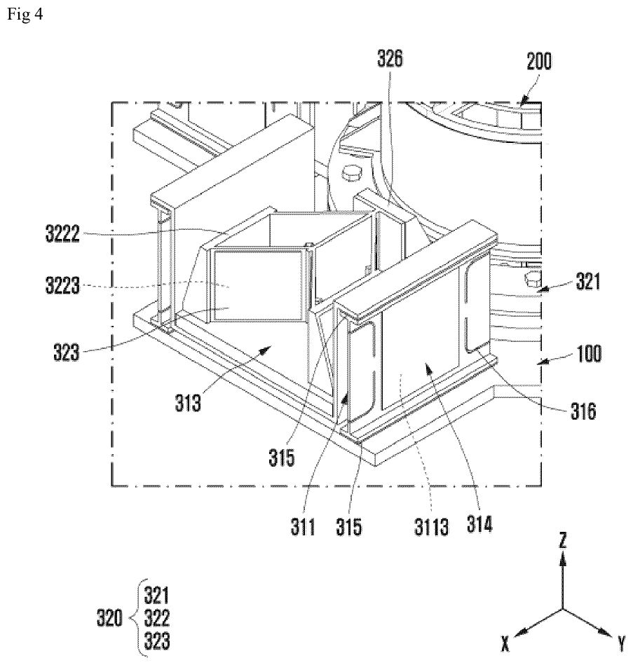

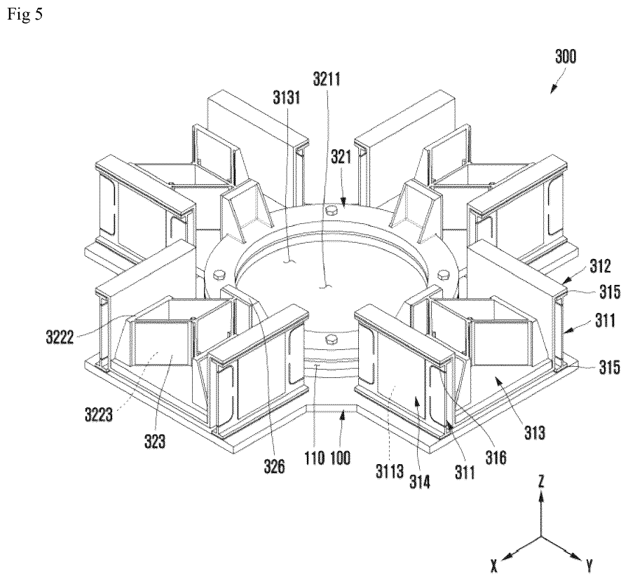

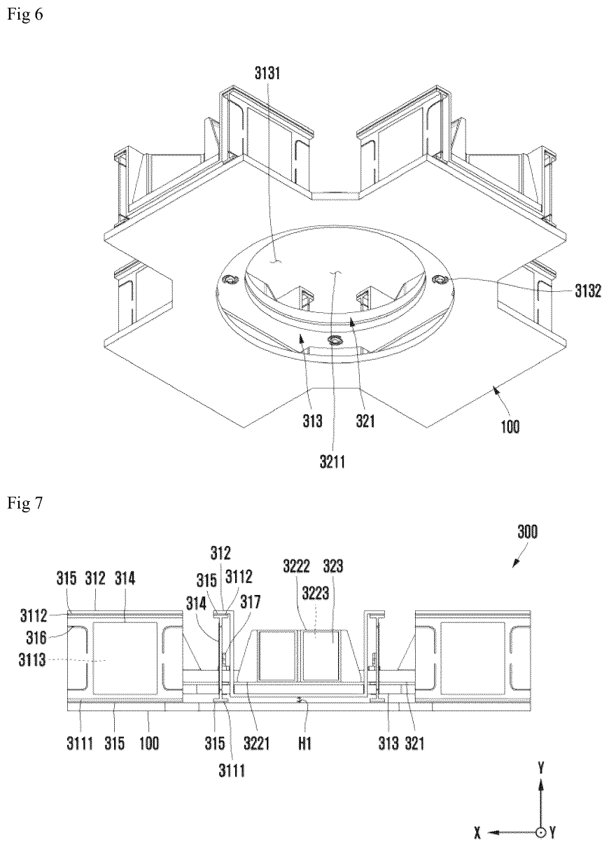

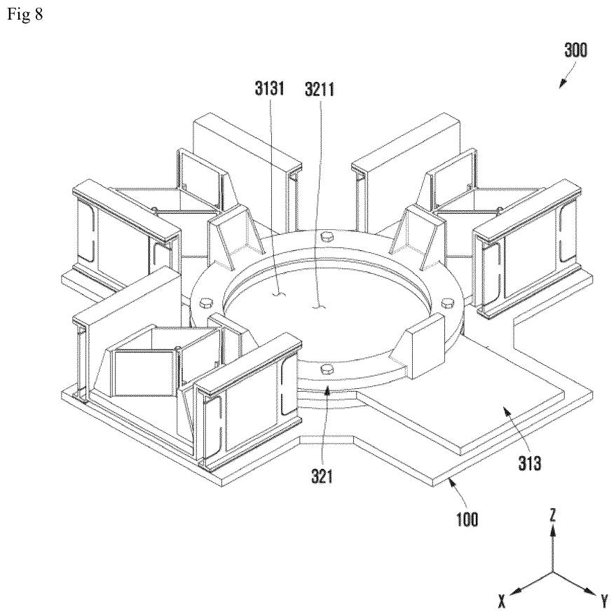

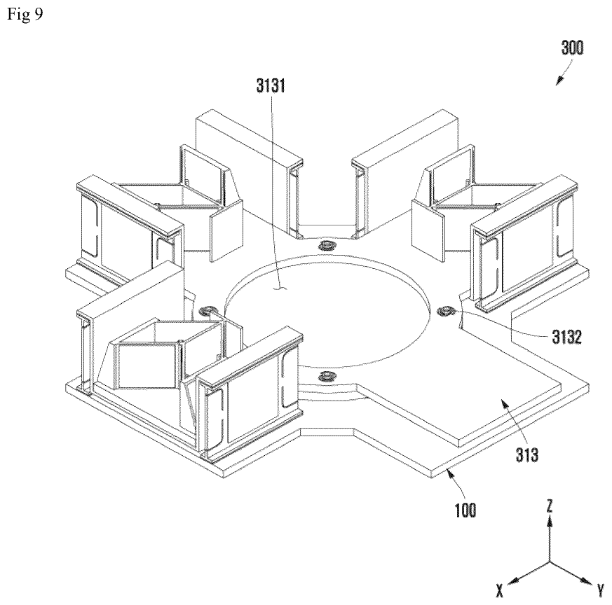

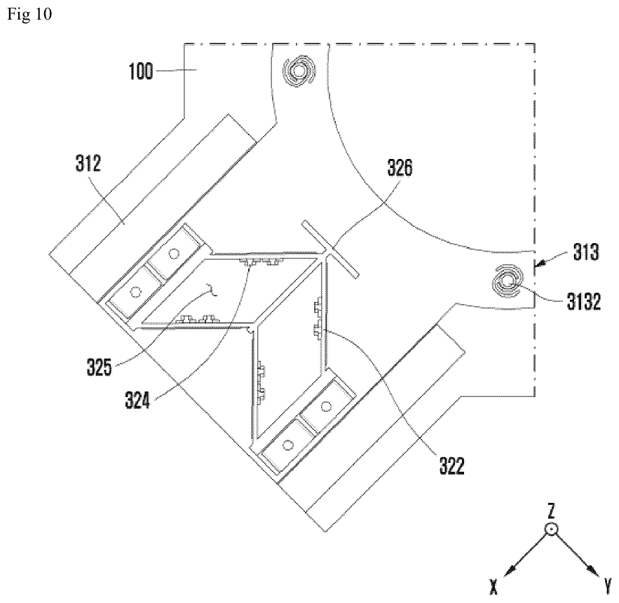

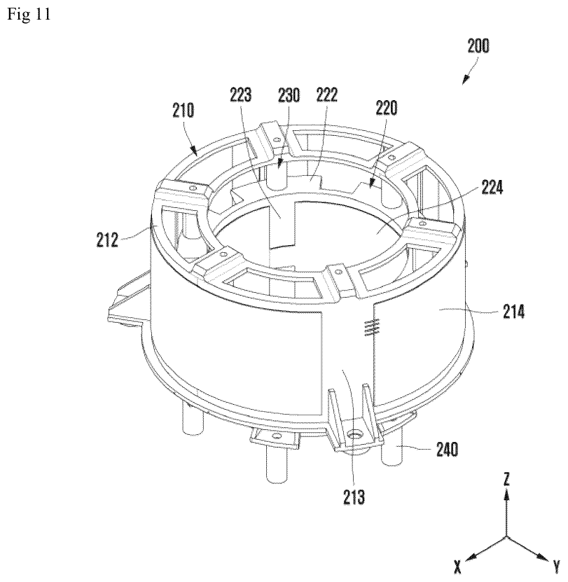

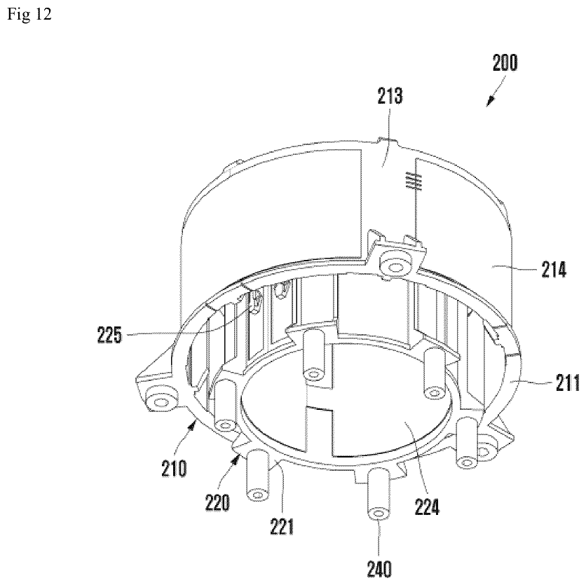

FIGS. 1 and 2 are perspective views of a precision positioning device according to one embodiment. FIG. 3 is a plan view of a precision positioning device according to one embodiment. FIG. 4 is an enlarged view of portion Ain FIG. 1. FIGS. 5 and 6 are perspective views of a second alignment unit according to an embodiment. FIG. 7 is a side view of a second alignment unit according to an embodiment. FIG. 8 is a perspective view of a second alignment unit according to an embodiment with a portion thereof omitted. FIG. 9 is a perspective view of a second alignment unit according to an embodiment with a portion thereof omitted. FIG. 10 is a plan view of a portion of the second alignment unit illustrated in FIG. 9. FIGS. 11 and 12 are perspective views of a first alignment unit according to an embodiment.

Referring to FIGS. 1 to 3, a precision positioning device (10) according to one embodiment may comprise a base plate (100), a first alignment unit (200), and a second alignment unit (300).

In an embodiment, a through-hole (110) may be formed in the base plate (100). The through-hole (110) may be formed at the center of the base plate (100) may be circular; however, the position and shape of the through-hole (110) are not limited thereto.

In one embodiment, the base plate (100) may be cross-shaped with a circular through-hole (110) formed at its center, and may have a shape symmetrical about another axis (e.g., parallel to the X-axis or parallel to the Y-axis) that is perpendicular to the central axis of the through-hole (110) (e.g., parallel to the Z-axis) passing through the center of the through-hole (110). However, the shape of the base plate (100) is not limited thereto.

In an embodiment, the first alignment unit (200) may be positioned on one side (e.g., the +Z side) of the base plate (100). In particular, the first alignment unit (200) may be positioned on one side (e.g., the +Z side) of the through-hole (110).

In an embodiment, the first alignment unit (200) can be fixed to the second alignment unit (300). In particular, the first alignment unit (200) may be fixed to the base plate (100) through the connecting plate (313) of the tilting portion (310) of the second alignment unit (300) to be described later and the connecting ring (321) of the translational movement portion (320) of the second alignment unit (300) to be described later. Although not shown, the first alignment unit (200) may be directly fixed to the base plate (100).

In an embodiment, an object (not shown) may be fixed to the first alignment unit (200). The object may be fixed to the first alignment unit (200), and its position may be finely adjusted according to the translational movement and rotational movement of the precision positioning device (10). That is, the precision positioning device (10) can change the position of the object. For example, the precision positioning device (10) may control the position of an object within a range from several nanometers to several thousand micrometers. Meanwhile, the object may be an optical component such as an optical camera. For example, the object could be a large electro-optical camera. The precision positioning device (10) may adjust the position of the object to focus the optical camera when the object is an optical camera.

In one embodiment, the second alignment unit (300) may be disposed so as to be spaced apart from the first alignment unit (200) in a radial direction of the precision positioning device (10) (e.g., a direction perpendicular to the Z-axis). The second alignment unit (300) can surround at least a portion of the first alignment unit (200).

In an embodiment, the second alignment unit (300) can be fixed to the base plate (100). For example, the second alignment unit (300) may be seated and secured on one surface (e.g., the surface on the +Z side) of the base plate (100).

Referring to FIGS. 4 to 7, in an embodiment, the second alignment unit (300) may include a tilting portion (e.g., the tilting portion (310) of FIGS. 1 to 3) configured to tilt the first alignment unit (200) by thermally expanding in response to a temperature change.

In an embodiment, the tilting portion may include at least one beam (311), a bracket (312), a connecting plate (313), and a beam heater (314).

In an embodiment, the second alignment unit (300) may include a plurality of tilting portions. A plurality of tilting portions may share a connecting plate (313) to be described later and/or a connecting ring (321) to be described later. For example, the second alignment unit (300) may include four tilting portions, wherein the four tilting portions may share one connecting plate (313) and one connecting ring (321).

In an embodiment, there may be a plurality of the at least one beam (311). As an example, eight beams (311) are illustrated in FIG. 5. The beam (311) may be I-shaped, but the shape of the beam is not limited thereto.

In one embodiment, the beam (311) may be in contact with the base plate (100) may extend in a first direction (e.g., +/−Z direction) perpendicular to the base plate (100).

In one embodiment, the beam (311) may comprise a first beam surface (3111) abutting the base plate (100), a second beam surface (3112) opposite the first beam surface, and a beam side surface (3113) disposed between the first beam surface and the second beam surface. The first beam surface (3111), second beam surface (3112) and beam side surface (3113) are clearly illustrated in FIG. 7.

In an embodiment, a beam heater (314) can be attached to the beam side surface (3113). In particular, the beam heater (314) can be attached to the beam side surface (3113) opposite the beam side surface facing the bracket (312).

In an embodiment, the beam heater (314) can heat the beam (311). The beam heater (314) can transfer heat to the beam (311) through the beam side surface (3113). The heated beam (311) can thermally expand. The beam (311) may comprise a metal material having a high coefficient of thermal expansion (e.g., stainless steel), but may also comprise a non-metal material.

In one embodiment, thermal expansion of the beam (311) may occur in multiple directions, including the first direction in which the beam extends. In particular, the length of the beam (311) in the first direction can increase due to thermal expansion.

In one embodiment, the bracket (312) may be disposed so as to be seated on one end of the beam (311) (e.g., the second beam surface (3112)) and spaced apart from the base plate (100). Referring to FIG. 7, it is clearly shown that the bracket (312) and the base plate (100) are spaced apart by a distance H1.

In an embodiment, the beam (311) can thermally expand to apply force to the bracket (312). In particular, the beam (311) can expand thermally and push out the bracket (312). For example, the beam (311), when heated by a beam heater (314) may thermally expand to increase its length in the first direction, thereby pushing the bracket (312) seated on the second surface (3112) of the beam in the first direction.

In one embodiment, the bracket (312) may comprise a portion extending in a first direction perpendicular to the base plate (100). The portion extending in the first direction may be substantially the same as the direction in which the beam (311) extends, and, in this case, the portions of the beam (311) and the bracket (312) may be positioned parallel to each other.

In one embodiment, the bracket (312) may include a portion extending in a direction parallel to the base plate (100) (e.g., parallel to the Z-axis).

In an embodiment, the connecting plate (313) can be seated on the bracket (312) and connected to the first alignment unit (200). Here, the fact that the connecting plate (313) is connected to the first alignment unit (200) may mean not only that the connecting plate (313) is directly connected to the first alignment unit (200) without any other component interposed therebetween, but also that the connecting plate (313) and the first alignment unit (200) may be indirectly connected with another component (e.g., a connecting ring (321)) interposed therebetween. A through-hole (3131) can be formed in the connecting plate (313). The through-hole (3131) may be formed at the center of the connecting plate (313) and may be circular; however, the position and shape of the through-hole (3131) are not limited thereto.

In one embodiment, the connecting plate (313) may be cross-shaped with a circular through-hole (3131) formed at its center, and may have a shape symmetrical about another axis (e.g., parallel to the X-axis or parallel to the Y-axis) that is perpendicular to the central axis of the through-hole (3131) (e.g., parallel to the Z-axis) passing through the center of the through-hole (3131). However, the shape of the connecting plate (313) is not limited thereto.

In one embodiment, the through-hole (3131) of the connecting plate (313) may be concentric with the through-hole (110) of the base plate (100), but is not limited thereto.

In an embodiment, the bracket (312) can apply force to the connecting plate (313). The beam (311), when heated by the beam heater (314) may thermally expand and increase in length in the first direction, thereby applying a force (e.g., a pushing force) in the first direction to the bracket (312) seated on the second surface (3112) of the beam, and accordingly, the bracket (312) may apply a force (e.g., a pushing force) in the first direction to the connecting plate (313). The connecting plate (313) of the tilting portion (310) of the second alignment unit (300) is connected to the first alignment unit (200), and the second alignment unit (300) surrounds at least a portion of the first alignment unit (200), so that the bracket (312) may consequently tilt the first alignment unit (200) by applying force to the connecting plate (313).

In an embodiment, a plurality of tilting portions (310) may share a connecting plate (313) with each other. The beam heater (314) of one tilting portion (310) may heat the beam (311), and the beam heaters (314) of the remaining tilting portions (310) may not heat the beam (311). In this case, the bracket (312) of the tilting portion (310) in which the beam heater (314) operates may apply a force in the first direction to the connecting plate (313), and the bracket (312) of the tilting portion (310) in which the beam heater (314) does not operate may not apply a force in the first direction to the connecting plate (313). At this time, since the shared connecting plate (313) receives force only from the tilting portion (310) in which the beam heater (314) operates, the first alignment unit (200) connected to the shared connecting plate (313) may consequently be tilted.

For example, among the four tilting portions (310) illustrated in FIG. 5, if only the beam heater (314) of the tilting portion (310) located on the +Y side heats the beams (311), the beams (311) may thermally expand in the +/−Z direction, so that the beams (311) apply a force to the bracket (312) in the +Z direction, and the bracket (312) can apply a force to the connecting plate (313) seated on the bracket (312) in the +Z direction. The connecting plate (313) is connected to the first alignment unit (200) illustrated in FIG. 1, although omitted in FIG. 5, so that the first alignment unit (200) can be tilted about the X-axis. However, it shall be understood that the tilting of the first alignment unit (200) may similarly be achieved when each of the plurality of tilting portions (310) includes a respective connecting plate (313) without sharing with each other, and the second alignment unit (300) further comprises another component that connects the individual connecting plates (313) of the plurality of tilting portions (310).

Tilting of the first alignment unit (200) can be performed not only about the X-axis but also about the Y-axis.

In an embodiment, the tilting portion (310) may further include a beam insulating member (315). A beam insulating member (315) may be interposed between the beam (311) and the bracket (312) and/or between the beam (311) and the base plate (100). For example, the beam insulating member (315) may be interposed between the second beam surface (3112) and the bracket (312), and may also be interposed between the first beam surface (3111) and the base plate (100).

The beam insulating member (315) may reduce or substantially block heat transfer so that heat delivered to the beam (311) by the beam heater (314) is not transferred to the bracket (312) and/or base plate (100) through the beam side surface (3113). The beam insulating member (315) can prevent heat transferred by the beam heater (314) from being transferred to other elements through the beam (311).

In an embodiment, a groove (316) may be formed on the beam side surface (3113) penetrating the beam side surface (3113). A plurality of grooves (316) can be formed in one beam (311).

In one embodiment, when one tilting portion (310) tilts the first alignment unit (200), the groove (316) of another tilting portion (310) can serve as a stopper to prevent excessive deformation of the other tilting portion (310) while providing space for the beam (311) of the other tilting portion (310) to deform. When the bracket (312) of one tilting portion (310) applies a force in the first direction to the connecting plate (313), the connecting plate (313) of the other tilting portion (310) opposite to one tilting portion (310) may apply a force in the opposite direction to the bracket (312) of the other tilting portion (310).

For example, among the four tilting portions (310) illustrated in FIG. 5, only the beam heater (314) of the tilting portion (310) located on the +Y side heats the beams (311) and applies force in the +Z direction to the connecting plate (313) seated on the bracket (312), so that when the first alignment unit (200) is tilted around the X axis, the connecting plate (313) of the tilting portion (310) located on the −Y side can apply force in the −Z direction to the bracket (312). At this time, the groove (316) formed through the beam side surface (3113) of the other tilting part (310) can serve as a stopper to prevent excessive deformation of the beam (311) of the other tilting part (310) while providing a space for the beam (311) of the other tilting part (310) to be deformed as its width decreases.

In an embodiment, the tilting portion may include a temperature sensor (317) attached to a surface opposite to the surface to which the beam heater (314) is attached to sense the temperature of the beam. The temperature sensor (317) can sense the temperature of the beam (311). The temperature sensor (317) is well illustrated in FIG. 7.

Referring again to FIGS. 4 through 7, in an embodiment, the second alignment unit (300) may include a translational movement portion (320) configured to thermally expand in response to a temperature change to cause the first alignment unit (200) to translationally move.

In an embodiment, the second alignment unit (300) may include a plurality of translational moving portions (e.g., translational movement portions (320) of FIGS. 1 to 3). A plurality of translational moving parts may share the aforementioned connecting plate (313) and/or the connecting ring (321) described below. For example, the second alignment unit (300) may include four translational movement portions (320), wherein the four translational movement portions (320) may share one connecting plate (313) and one connecting ring (321).

In an embodiment, the translational movement portion (320) may include a connecting ring (321) and a pusher (322).

In an embodiment, a connecting ring (321) can be coupled to a connecting plate (313). The connecting ring can be screw-coupled to the connecting plate (313). When the connecting plate (313) and the connecting ring are coupled, a flexure groove (3132) can be formed around the screw hole of the connecting plate (313). The flexure groove (3132) can serve as a stopper to limit excessive movement of the second alignment unit (300) while providing spatial clearance to allow smooth relative movement of the second alignment unit (300) with respect to the first alignment unit (200). The flexure groove (3132) is well illustrated in FIG. 10.

In an embodiment, a first alignment unit (200) may be connected to a connecting ring (321). For example, the first alignment unit (200) can be screw-coupled to the connecting ring (321). The connecting plate (313) can be connected to the first alignment unit (200) via a connecting ring (321).

In an embodiment, the connecting ring (321) may be formed with a through hole (3211) concentric with the through hole (110) of the base plate and/or the through hole (3131) of the connecting plate.

In an embodiment, the pusher (322) may be positioned radially outward of the connecting ring (321).

In an embodiment, the pusher (322) may be positioned between the beams (311) of the tilting portion (310) and secured to the connecting plate (313). For example, the pusher (322) can be fixed by crew-coupling to the connecting plate (313).

In an embodiment, the pusher (322) may include a first pusher surface (3221) facing the connecting plate (313), a second pusher surface (3222) opposite the first pusher surface, and a pusher side surface (3223) positioned between the first pusher surface and the second pusher surface.

In an embodiment, the pusher (322) may include at least one pusher heater (323). The pusher heater (323) can be attached to the pusher side surface (3223). For example, the pusher heater (323) can be attached to the outer pusher side surface among the pusher side surfaces.

In an embodiment, the pusher heater (323) can heat the pusher (322). The pusher heater (323) can transfer heat to the pusher (322) through the pusher side surface (3223). The heated pusher (322) can be thermally expanded. For example, the pusher (322) may include a metal material having a high coefficient of thermal expansion (e.g., stainless steel), but may also include other materials besides metal.

In an embodiment, thermal expansion of the pusher (322) can occur in multiple directions, including the radial direction. The heated pusher (322) may thermally expand, thereby increasing the radial length of the pusher (322). For example, the pusher (322) of the translational movement portion (320) located on the +X side of FIG. 5 may thermally expand in the +/−X direction, so that the +/−X direction length of the pusher (322) in the +/−X direction may increase.

In an embodiment, the pusher (322) can thermally expand to apply force to the connecting ring (321). In particular, the pusher (322) can expand thermally to push the connecting ring (321). The pusher (322) heated by the pusher heater (323) expands thermally and increases in length in the radial direction, thereby applying a radial force (e.g., a pushing force) to the connecting ring (321). For example, the pusher (322) of the translational movement portion (320) located on the +X side of FIG. 5 can thermally expand in the +/−X direction, so that the length of the pusher (322) in the +/−X direction increases, and the pusher (322) can apply a force in the −X direction to the connecting ring (321).

In an embodiment, a plurality of translational movement portions (320) may share a connecting ring (321) with each other. The pusher heater (323) of one translational movement portion (320) may heat the pusher (322), and the pusher heaters (323) of the other translational movement portions (320) may not heat the pusher (322). In this case, the pusher (322) of the translational movement portion (320) in which the pusher heater (323) operates may apply a force in the radial direction to the connecting ring (321), and the pusher (322) of the translational movement portion (320) in which the pusher heater (323) does not operate may not apply a force in the radial direction to the connecting ring (321). At this time, the shared connecting ring (321) receives force only from the translational movement portion (320) on which the pusher heater (323) operates, so that the first alignment unit (200) connected to the shared connecting ring (321) can be consequently translationally moved. However, itis to be understood that the translational movement of the first alignment unit (200) may be similarly performed when each of the plurality of translational movement portions (320) includes a respective connecting ring (321) without sharing with each other, and the second alignment unit (300) further includes another component that connects the individual connecting rings (321) of the plurality of translational movement portions (320).

For example, among the four tilting portions (310) illustrated in FIG. 5, if only the pusher heater (323) of the translational movement portion (320) located on the +X side heats the pusher (322), the pusher (322) can thermally expand in the +/−X direction so that the pusher (322) can apply force to the connecting ring (321) in the −X direction. The connecting ring (321) is connected to the first alignment unit (200) illustrated in FIG. 1, although omitted in FIG. 5, so that as a result, the first alignment unit (200) can translationally move in the −X direction.

It goes without saying that the translational movement of the first alignment unit (200) can be performed not only in the −X direction, but also in the +X direction and the +/−Y direction.

In an embodiment, the translational movement portion (320) may include a temperature sensor (324) that senses the temperature of the pusher. The temperature sensor (324) is placed in a cavity (325) formed in the pusher (322), and the pusher heater (323) can be attached to a surface other than the surface on which the temperature sensor (324) is placed (e.g., the outer pusher side surface (3223)). The temperature sensor (324) is well illustrated in FIG. 10.

In an embodiment, the translational movement portion (320) may include a pusher insulating member (326) interposed between the pusher (322) and the connecting ring (321). The pusher insulating member (326) can reduce or substantially block heat transfer so that the heat transferred to the pusher (322) by the pusher heater (323) is not transferred to the connecting ring (321). The pusher insulating member (326) can prevent heat transferred by the pusher heater (323) from being transferred to other elements through the pusher (322).

FIGS. 8 and 9 are drawings in which the tilting portion (310) and the translational movement portion (320) located on the −Y side among the four tilting portions (310) and translational movement portions (320) included in the second alignment unit (300) of FIG. 5 are omitted. FIG. 9 is a drawing of FIG. 8 with the connecting ring omitted. FIG. 10 is a plan view of the tilting portion (310) and the translational movement portion (320) located on the +X side of FIG. 9 (however, the connecting ring (321) of the translational movement portion (320) is omitted).

Referring to FIGS. 11 and 12, in an embodiment, the first alignment unit (200) may include a first body (210), a first body heater (214), a second body (220), a second body heater (224), and an isolator (230).

In an embodiment, the first body (210) can extend in a first direction perpendicular to the base plate (100). A hollow space concentric with the through-hole (110) of the base plate can be formed in the first body (210). The first body (210) can be coupled to a connecting ring (321) and/or a connecting plate (313). As a result, the first body (210) can be connected and fixed to the base plate (100) via the second alignment unit (300).

In an embodiment, the first body (210) may include a first body surface (211), a second body surface (212) opposite the first body surface, and a first body side surface (213) positioned between the first body surface and the second body surface.

In an embodiment, the first body (210) can surround at least a portion of the second body (220). In particular, the first body can surround the upper side (e.g., the +Z side) of the second body (220).

In an embodiment, the second body (220) can extend in the first direction. A hollow space concentric with the through-hole (110) of the base plate can be formed in the second body (220). An object (not shown) can be fixed to the second body (220). The object can be fixed to the second body (220) by being fitted to a fixing element (240) arranged on the first surface (221) of the second body. However, the method of fixing the object is not limited to this.

In an embodiment, the second body (220) may include a second body first surface (221), a second body second surface (222) opposite the second body first surface, and a second body side surface (223) positioned between the second body first surface and the second body second surface.

In an embodiment, the first body heater (214) may be attached to the first body side surface (213). In particular, the first body heater (214) may be disposed on the first body side surface (213) positioned on a radially outer side. In an embodiment, the second body heater (224) may be attached to the second body side surface (223). In particular, the second body heater (224) may be disposed on the second body side surface (223) positioned on a radially inner side.

In an embodiment, the isolator (230) can connect the second body surface (212) and the second body surface (222) to each other in the first direction while spacing them apart by a certain distance. The isolator (230) ensures that the distance between the first body (210) and the second body (220) remains constant even if at least one of the first body and the second body (220) undergoes thermal expansion.

In an embodiment, the first body heater (214) can heat the first body, and the second body heater (224) can heat the second body (220). The first body heater (214) can transfer heat to the first body (210) through the first body side surface (213). The heated first body (210) can thermally expand. The second body heater (224) can also transfer heat to the second body (220) through the second body side surface (223). The heated second body (220) can thermally expand. For example, the first body (210) and/or the second body (220) may include a metal material having a high coefficient of thermal expansion (e.g., stainless steel), but may also include other materials besides metal.

In an embodiment, the second body (220) may include a temperature sensor (225). The temperature sensor (225) can be located on the second body side surface opposite the second body side surface (223) to which the second body heater (224) is attached.

In an embodiment, thermal expansion of the first body (210) and/or the second body (220) may occur in multiple directions, including the first direction. The heated first body (210) and/or second body (220) may thermally expand, so that the length of the first body (210) and/or second body (220) in the first direction may increase.

In an embodiment, when the first body (210) thermally expands, the second body (220) can translationally move in the first direction, and when the second body (220) thermally expands, the first body can translationally move in the first direction. The first body (210) can be coupled to the connecting ring (321) and/or the connecting plate (313), so that the first body (210) can be connected and fixed to the base plate (100) via the second alignment unit (300).

In an embodiment, when the first body (210) thermally expands and increases in length in a first direction (e.g., +/−Z direction), the second body (220) connected at a certain distance by the isolator (230) translationally moves in the first direction by an amount equal to the increase in length of the first body (210). For example, if the first body (210) increases in length in the +Z direction with respect to the base plate (100), the second body (220) translationally moves in the +Z direction by that length. The object fixed to the second body (220) translationally moves in the +Z direction.

Conversely, when the second body (220) thermally expands and increases in length in the first direction, the second surface (222) of the second body can translationally move in a second direction (e.g., −/+Z direction) opposite to the first direction. Since the first body (210) is coupled to the connecting ring (321) and is fixedly connected to the base plate (100), when the length of the second body (220) increases in the −Z direction with respect to the base plate (100), the first surface (221) of the second body translationally moves in the −Z direction by that length. The object fixed to the second body (220) translationally moves in the −Z direction.

Referring to the drawings above, a precision positioning device (10) according to an embodiment can adjust the position and angle of an object using thermal expansion, tilt or translationally move the object, and perform multi-axis control of the object.

Although the embodiments have been described above with reference to limited drawings, those skilled in the art can apply various technical modifications and variations based on the above. For example, suitable results may be achieved even if the described techniques are performed in a different order than described, and/or components of the described systems, structures, devices, or circuits are combined or assembled in a different manner than described, or replaced or substituted by other components or equivalents.

Therefore, other implementations, other embodiments, and equivalents to the claims also fall within the scope of the claims described below.

1. A precision positioning device for adjusting the position of an object, comprising:
a base plate in which a through-hole is formed;
a first alignment unit positioned on one side of the through-hole and configured such that the object is fixed thereto; and
a second alignment unit surrounding at least a portion of the first alignment unit and fixed to the base plate;
wherein the second alignment unit includes a tilting portion configured to tilt the first alignment unit by thermally expanding according to a temperature change.

2. The precision positioning device of claim 1, wherein
the tilting portion comprises:
at least one beam that is in contact with the base plate and extends in a first direction perpendicular to the base plate; a bracket that is seated on one end of the beam and installed to be spaced apart from the base plate; and a connecting plate that is seated on the bracket and connected to the first alignment unit;
wherein the beam is configured to thermally expand in the first direction according to a temperature change and apply force to the bracket.

3. The precision positioning device of claim 2, wherein
the beam includes a first beam surface in contact with the base plate, a second beam surface opposite to the first beam surface, and abeam side surface positioned between the first beam surface and the second beam surface,
and the tilting portion comprises at least one beam heater attached to the beam side surface.

4. The precision positioning device of claim 3, wherein
the tilting portion includes a beam insulating member interposed between the second surface of the beam and the bracket.

5. The precision positioning device of claim 3, wherein
a groove penetrating the beam side surface is formed on the beam side surface.

6. The precision positioning device of claim 5, wherein
the second alignment unit includes a plurality of the tilting portions, and
when one of the pluralities of tilting portions tilts the connecting plate, the width of the groove of at least one other tilting portion decreases.

7. The precision positioning device of claim 3, wherein
the tilting portion includes a temperature sensor attached to a surface opposite to the surface to which the beam heater is attached, the temperature sensor configured to sense the temperature of the beam.

8. The precision positioning device of claim 2, wherein
the second alignment unit comprises a translational movement portion configured to translationally move the first alignment unit in a radial direction of the precision positioning device by thermally expanding according to a temperature change.

9. The precision positioning device of claim 8, wherein
the translational movement portion comprises:
a connecting ring coupled to the connecting plate; and
a pusher positioned radially outside the connecting ring;
wherein the pusher is configured to apply force in the radial direction to the connecting ring by thermally expanding according to a temperature change.

10. The precision positioning device of claim 9, wherein
the pusher includes a first pusher surface facing the connecting plate, a second pusher surface opposite to the first pusher surface, and a pusher side surface positioned between the first pusher surface and the second pusher surface, and
the translational movement portion includes at least one pusher heater attached to the pusher side surface.

11. The precision positioning device of claim 10, wherein
the translational movement portion includes a temperature sensor that senses the temperature of the pusher, and
the temperature sensor is placed in a cavity formed in the pusher, and the pusher heater is attached to a surface other than the surface on which the temperature sensor is placed.

12. The precision positioning device of claim 9, wherein
the translational movement portion includes a pusher insulating member interposed between the pusher and the connecting ring.

13. The precision positioning device of claim 9, wherein
the connecting plate and the connecting ring are screw-coupled, and
a flexure groove is formed in the connecting plate around a screw hole of the connecting plate.

14. The precision positioning device of claim 1, wherein
the first alignment unit further comprises:
a first body extending in a first direction perpendicular to the base plate, having a hollow formed concentrically with a through-hole of the base plate, and including a first body surface, a second body surface opposite to the first body surface, and a first bodyside surface positioned between the first body surface and the second body surface; and
a second body extending in the first direction, at least partially surrounded by the first body, including a second body first surface, a second body second surface opposite the second body first surface, and a second body side surface positioned between the second body first surface and the second body second surface;
wherein at least one of the first body and the second body is configured to thermally expand in the first direction according to a temperature change.

15. The precision positioning device of claim 14, wherein
the first alignment unit further comprises:
an isolator that connects the second surface of the first body and the second surface of the second body to each other in the first direction while separating them by a certain distance;
a first body heater attached to the first body side surface; and
a second body heater attached to the second body side surface;
wherein, when the first body thermally expands, the second body translationally moves in the first direction, and when the second body thermally expands, the second surface of the second body translationally moves in a second direction opposite to the first direction.
